(19) United States
(12) Patent Application Publication
(10) Pub. No.: US 2011/0137684 A1
(43) Pub. Date: Jun. 9, 2011

(54) SYSTEM AND METHOD FOR GENERATING TELEMATICS-BASED CUSTOMER CLASSIFICATIONS

(76) Inventors: David F. Peak, Avon, CT (US); Andrew J. Amigo, Gloucester, MA (US)

(21) Appl. No.: 12/633,366

(22) Filed: Dec. 8, 2009

(51) Int. Cl. G06Q 40/00; G06Q 30/00; G06F 17/30

(52) U.S. Cl. 705/4; 707/737; 707/E17.046

(57) ABSTRACT

A method includes a computer which receives telematics data relating to a vehicle operated by a driver. The telematics data is associated with a match index. The match index indicates that the telematics data is pertinent to the driver without indicating the driver's identity. The computer receives other data relating to the driver. The other data is associated with the match index. The computer uses the match index to associate the telematics data with the other data. The computer uses the associated telematics data and the other data to generate a driver classification for the driver.

### FIELD

The present invention relates to computerized marketing activities with respect to insurance policies.

### BACKGROUND

Telematics are increasingly utilized in connection with both commercial and household vehicles. Telematics entails installation of one or more sensors on a motor vehicle for the purpose of monitoring the use and/or condition of the motor vehicle. One known type of telematics system may be operated by a motor vehicle manufacturer. According to one feature of such a system, the system monitors a subscriber vehicle for occurrence of a collision, and in the event of detecting a collision, automatically determines the vehicle location and automatically dispatches assistance.

The insurance industry has recognized the potential of telematics for loss prevention and underwriting applications. For example, it has been proposed to automatically monitor the times and locations of vehicle operation and/or the manner in which the vehicle is operated to generate a score which indicates a degree of risk involved in the vehicle's customary patterns of operation.

The present inventors have recognized that telematics also has potential for use in identifying drivers who would be desirable prospects for marketing efforts relating to automobile liability insurance policies. However, one potential barrier in identifying automobile insurance marketing prospects relates to information privacy rules which may inhibit analysis of telematics or other data for prospect identification purposes.

### SUMMARY

An apparatus, method, computer system and computer-readable data storage medium are disclosed which include a computer receiving telematics data which is related to a vehicle operated by a driver. The telematics data is associated with a match index. The match index indicates that the telematics data is pertinent to the driver without indicating the driver's identity. The apparatus, method, computer system and computer-readable data storage medium also include the computer receiving other data that is related to the driver. The other data also is associated with the match index. The apparatus, method, computer system and computer-readable data storage medium also include the computer using the match index to associate the telematics data with the other data. Further, the apparatus, method, computer system and computer-readable data storage medium include the computer using the telematics data and the other data which have been associated with each other to generate a driver classification for the driver.

In this manner, a driver classification may be generated without relying on information that is identifiable to the driver. The resulting classification may be useful in marketing activities for automobile insurance policies, including selection of suitable prospects for marketing offers, and dispatching the offers to the prospects.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a block diagram of a system provided according to aspects of the present invention.

FIG. 2 is a block diagram that provides another representation of aspects of the system of FIG. 1.

FIG. 3 is a somewhat functional block diagram representation of a computer that is part of the system of FIG. 1.

FIG. 4 is an alternative block diagram representation of the computer of FIG. 3.

FIG. 5 is a block diagram representation of another computer that is part of the system of FIG. 1.

FIG. 6 is a flow chart that illustrates a process that may be performed in accordance with aspects of the present invention by the computer depicted in FIGS. 3 and 4.

FIG. 7 is a flow chart that illustrates a process that may be performed in accordance with aspects of the present invention by the computer depicted in FIG. 5.

### DETAILED DESCRIPTION

In general, and for the purposes of introducing concepts of embodiments of the present invention, an index that does not identify a driver is used to tag telematics data and other data related to the driver and received from separate sources. The index may, for example, be a vehicle identification number (VIN). The other data may, for example, indicate an insurance loss history for the driver. Because of the “blind” tagging of the data, it may be provided by the source to a third party without compromising the driver's privacy. The blind index tag (also referred to as a “match index”) is used to match the telematics data with the insurance loss history data for the driver. The resulting combined set of data may then be analyzed, processed and/or categorized to generate a classification for the driver. The classification may indicate that the driver is a suitable prospect for automobile insurance marketing activities.

The computer which matches the telematics and loss history data together and generates the driver classifications may export the classifications to another computer which screens the classification to identify suitable marketing prospects. An offer that is appropriate for the prospects may be transmitted to them by a suitable mechanism such as e-mail, or via an advertising download to a web-enabled smart mobile phone.

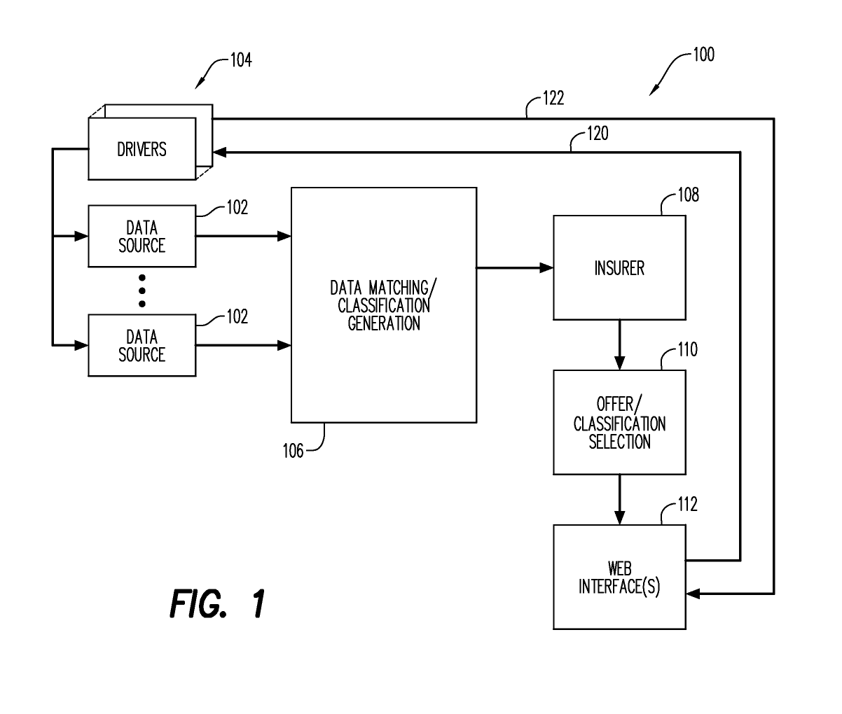

FIG. 1 is a block diagram of a system 100 provided according to aspects of the present invention. The system 100 includes a number of data sources 102, which provide data relating to a population of drivers 104. There may be two or more than two of the data sources 102 in the system 100.

One of the data sources 102 may be a vendor of telematics services (“telematics vendor”). The telematics vendor may have installed one or more sensors on each of the vehicles driven by the drivers 104. Data generated by the sensors is transmitted via telecommunications to one or more computers (not separately shown) operated by or on behalf of the telematics vendor. The telematics vendor computer(s) may store the data from the sensors and also may aggregate, analyze and/or process the data. The data (“telematics data”) that the telematics vendor provides may be raw sensor data or may be derived from the sensor data by aggregation, analysis, etc. For example, the telematics data provided as to a given vehicle may indicate at what times of day, and in what sorts of environments (urban vs. rural, etc.), the vehicle is customarily driven. In addition or alternatively, the telematics data may be indicative of occasional and/or habitual driver behaviors such as speeding, abrupt maneuvering, etc. Those who are skilled in the art will recognize the many other types of telematics data that may be available from a telematics vendor.

As an alternative to gathering telematics data by sensors installed in vehicles, the times and place of driving may be tracked via the driver's mobile telephone.

In some embodiments, one or more of the other data sources 102 may provide data that indicates insurance loss histories for the drivers 104. As is understood by those who are skilled in the art, a loss history indicates whether and when a driver has been the operator of a vehicle that was involved in an accident. The data source may be an insurance carrier that covered some or all of the drivers 104, or may be a clearinghouse for vehicle accident information.

In some embodiments, one or more of the other data sources 102 may be a state motor vehicle department (DMV) or an entity that collects information available from DMVs. For example, the DMV information may indicate whether and when the drivers 104 were cited for moving violations.

In some embodiments, one or more of the other data sources 102 may be a provider of demographic information (e.g., age, gender, income bracket, region or town of residence, etc.)

In some embodiments, one or more of the other data sources 102 may be a credit bureau, and the information provided may be credit scores for the drivers.

In some embodiments, one or more of the data sources 102 may be vehicle maintenance providers and the information provided may include records of vehicle maintenance such as oil changes, tire rotations, etc.

Some or all of the data sources 102 may make the information available at regular intervals, such as monthly, quarterly or annually. In addition or alternatively, some or all of the data sources 102 may report data in response to occurrences such as vehicle accidents or moving violation convictions.

Referring again to FIG. 1, the system 100 also includes a computer 106 which receives the driver-related information from the data sources 102. As described in more detail below, the computer 106 processes the driver-related information to generate driver classifications that may be useful for marketing purposes. (Consequently, the computer 106 will hereinafter be referred to as the “driver classification computer”.) As will be seen, the data received by the driver classification computer 106 and the driver classifications generated by the driver classification computer 106 are tagged in such a way that the drivers themselves are not identifiable from the data or from the classifications.

Continuing to refer to FIG. 1, the system 100 further includes an insurance company computer 108 which receives the driver classifications from the driver classification computer 106. In addition, the system 100 includes another computer 110 which receives the driver classifications from the insurance company computer 108 and which selects marketing prospects and/or marketing offers based on the driver classifications. The computer 110 (hereinafter, the “offer selection computer”) transmits offers to selected ones of the drivers via one or more web interfaces 112 that are also part of the system 100. The web interface(s) 112 may, for example, include one or more electronic mail systems and/or one or more mobile telephone networks. The transmission of offers to drivers is indicated in FIG. 1 by an arrow 120, and the drivers' responses to the offers are indicated by an arrow 122. The drivers' responses to offers may be received and processed by the offer selection computer 110 via the web interface(s) 112.

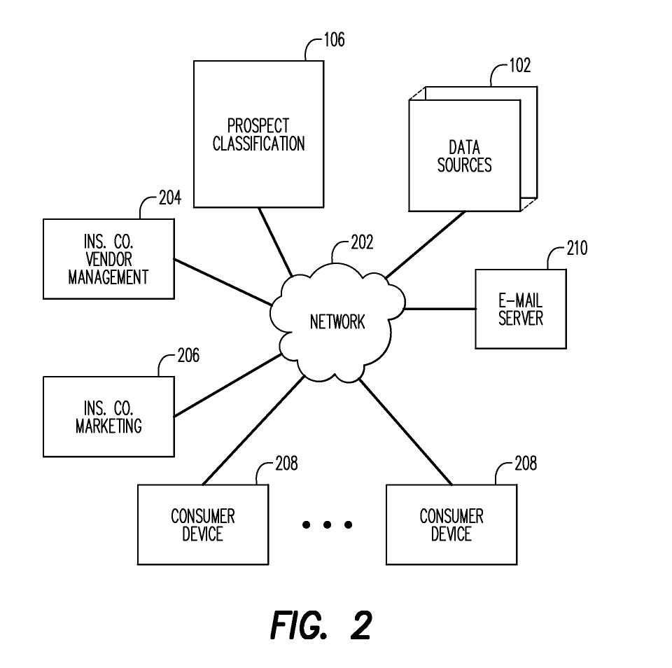

FIG. 2 is another block diagram that presents the system 100 in a somewhat more expansive or comprehensive fashion (and/or in a more hardware-oriented fashion).

In addition to the driver classification computer 106 (shown both in FIGS. 1 and 2), the system 100, as depicted in FIG. 2, also includes a conventional data communication network 202 to which the driver classification computer 106 is coupled. The data communication network 202 may for example include one or both of a public data communication network such as the Internet and one or more private data communication networks. (A portion of the data communication network 202 may also be constituted by the data communication capabilities of one or more mobile telephone networks, which are not separately shown.) Also shown in FIG. 2 as being connected to the data communication network 202 are the data sources 102 which were described above in connection with FIG. 1. Each data source 102 may, for example, include one or more computers, which are not separately shown.

Also coupled to the data communication network 202 is an insurance company vendor management computer 204, which may correspond to the insurance company computer 108 shown in FIG. 1. Still further, an insurance company marketing computer 206 is also coupled to the data communication network 202. The insurance company marketing computer 206 may correspond to the offer selection computer 110 shown in FIG. 1.

Still further, FIG. 2 shows, as parts of the system 100, consumer devices 208, which are also coupled to the data communication network 302. The consumer devices 208 belong to the drivers represented by block 104 in FIG. 1, and may for example include the driver's home computers, PDAs (personal digital assistants), smart (web-enabled) mobile phones, etc.

The system 100 may also include one or more electronic mail servers, which are represented by block 210 in FIG. 2. The electronic mail servers 210 provide a capability for electronic mail messages to be sent for delivery to the drivers via the consumer devices 208.

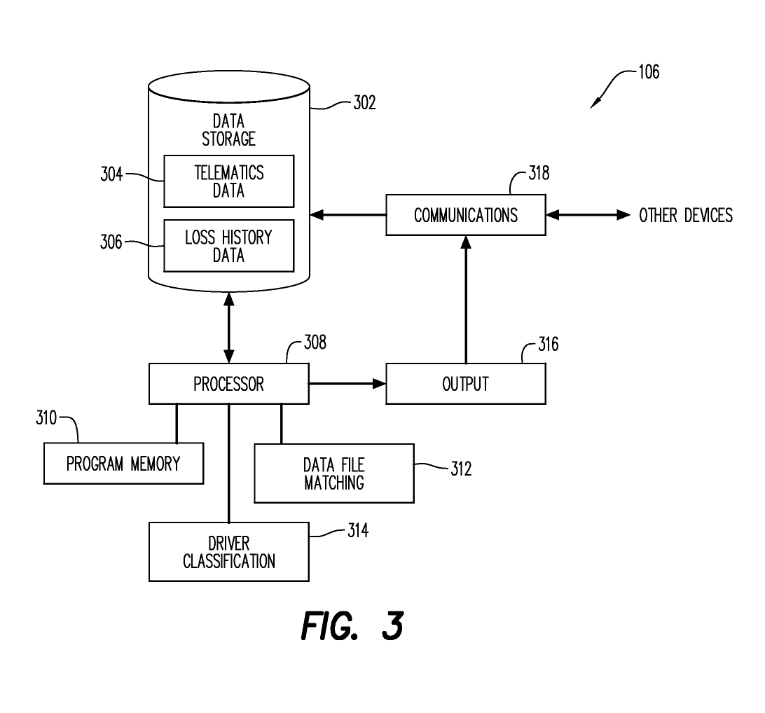

FIG. 3 is a somewhat functional block diagram representation of the driver classification computer 106 that is shown in FIGS. 1 and 2.

As seen from FIG. 3, the driver classification computer 106 includes a data storage module 302. In terms of its hardware the data storage module 302 may be conventional, and may be composed, for example, by one or more magnetic hard disk drives. A function performed by the data storage module 302 is to receive, store and provide access to telematics data (block 304) and other driver-related data such as loss history data (block 306). From earlier discussion, it will be appreciated that this data may have been provided by two or more of the data sources 102 shown in FIGS. 1 and 2.

The driver classification computer 106 also may include a computer processor 308. The computer processor 308 may include one or more conventional microprocessors and may operate to execute programmed instructions to provide functionality as described herein. Among other functions the computer processor 308 may store and retrieve the telematics data 304 and the loss history data 306 in and from the data storage module 302. It will be appreciated that for this purpose the computer processor 308 may be in communication with the data storage module 302.

The driver classification computer 106 may further include a program memory 310 that is coupled to the computer processor 308. The program memory 310 may include one or more fixed storage devices, such as one or more hard disk drives, and one or more volatile storage devices, such as RAM (random access memory). The program memory 310 may be at least partially integrated with the data storage module 302. The program memory 310 may store one or more application programs, an operating system, device drivers, etc., all of which may contain program instruction steps for execution by the computer processor 308.

The driver classification computer 106 further includes a data file matching component 312. In certain practical embodiments of the driver classification computer 106, the data file matching component 312 may effectively be implemented via the computer processor 308, and one or more application programs stored in the program memory 310. The data file matching component 312 may operate in accordance with aspects of the present invention. A function of the data file matching component 312 is to match together data related to a single driver and received by the driver classification computer 106 from two or more different data sources 102. Details of operation of the data file matching component 312 will be provided below.

Continuing to refer to FIG. 3, the driver classification computer 106 also includes a driver classification component 314. Again, in certain practical embodiments of the driver classification computer 106, the driver classification component 314 may effectively be implemented via the computer processor 308, and one or more application programs stored in the program memory 310. The driver classification component 314 may operate in accordance with aspects of the present invention. A function of the driver classification component 314 is to use sets of driver data formed by the data file matching component 312 to generate classifications for the corresponding drivers. Details of operation of the driver classification component 314 will be provided below.

The driver classification computer 106 may also include an output device 316. The output device 316 may be coupled to the computer processor 308. A function of the output device 316 may be to output to another device the driver classifications generated by the driver classification component 314.

Still further, the driver classification computer 106 may include a communication device 318. The communication device 318 may be provided to facilitate communication between driver classification computer 106 and other devices. The communication device 318 may be coupled (either directly or via the computer processor 308) to the output device 316 and to the data storage module 302. For example, the telematics data and the loss history data or other driver-related data may be received via the communication device 318 for storage in the data storage module 302. Also, the driver classifications output from the output device 316 may be transmitted to other devices from the driver classification computer 106 via the communication device 318.

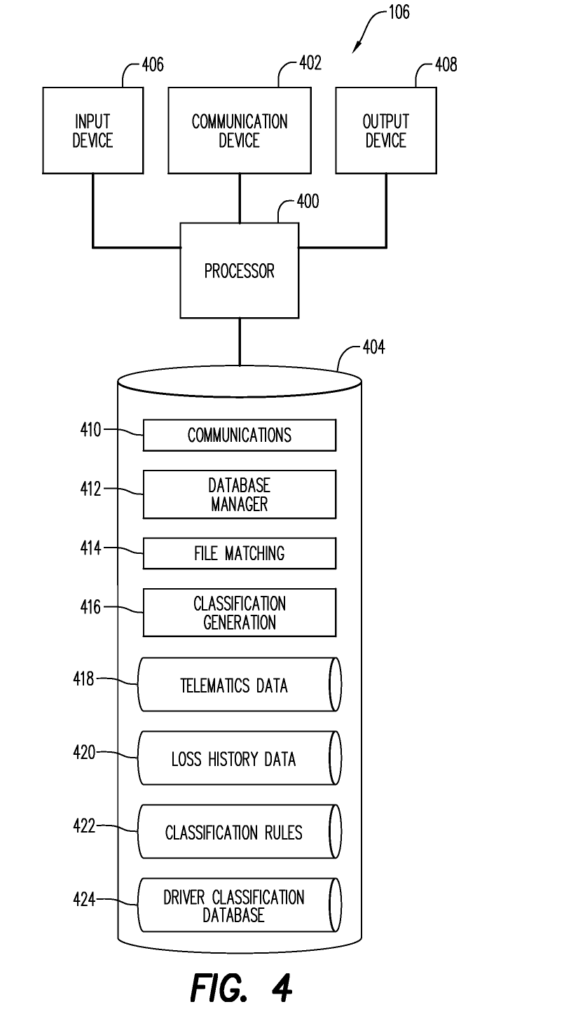

FIG. 4 is an alternative representation, in block diagram form, of the driver classification computer 106.

As depicted in FIG. 4, the driver classification computer 106 includes a computer processor 400 (which may correspond to the processor 308 shown in FIG. 3) operatively coupled to a communication device 402, a storage device 404, one or more input devices 406 and one or more output devices 408.

Communication device 402 may correspond to the communication device 318 shown in FIG. 3, and may be used to facilitate communication with, for example, other devices (such as computers shown as elements 102 and 204 in FIG. 2). Continuing to refer to FIG. 4, the input device(s) 406 may comprise, for example, a keyboard, a keypad, a mouse or other pointing device, a microphone, knob or a switch, an infra-red (IR) port, a docking station, and/or a touch screen. The input device(s) 406 may be used, for example, to enter information. Output device(s) 408 may comprise, for example, a display (e.g., a display screen), a speaker, and/or a printer.

Storage device 404 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices. At least some of these devices may be considered computer-readable storage media, or may include such media. The storage device 404 shown in FIG. 4 may encompass the data storage module 302 and the program memory 310 shown in FIG. 3.

In some embodiments, the hardware aspects of the driver classification computer 106 may be entirely conventional.

Storage device 404 stores one or more programs (at least some of which being indicated by blocks 410-416) for controlling processor 400. Processor 400 performs instructions of the programs, and thereby operates in accordance with aspects of the present invention. In some embodiments, the programs may include a conventional data communication program 410 that programs the driver classification computer 106 to engage in data communications with other devices.

Another program stored on the storage device 404 is indicated at block 412 and is a conventional database management program, which establishes and maintains databases (discussed below) stored in the storage device 404 and utilized in processing performed by the processor 400.

Still another program stored on the storage device 404 is indicated at block 414. Program 414 may operate in accordance with aspects of the present invention to control the driver classification computer 106 to match telematics data files with other data files that correspond to the same driver. Details of operation of program 414 will be described below.

Continuing to refer to FIG. 4, storage device 404 also stores a program 416, which operates to control the driver classification computer 106 to analyze sets of files matched together by the file matching program 414 so as to produce driver classifications. The program 416 may operate in accordance with aspects of the present invention. Details of operation of program 416 will be described below.

There may also be stored in the storage device 404 other software, such as one or more conventional operating systems, device drivers, website hosting software, etc.

Still further, the storage device 404 may store a database 418 for storing and managing the telematics data discussed above and represented by block 304 in FIG. 3. In addition, the storage device 404 may store a database 420 which contains the loss history data (or other driver-related data) as discussed above and represented by block 306 in FIG. 3. Also, the storage device 404 may store a database 422 for storing and managing rules that the classification generation program 416 applies in analyzing the matched sets of telematics and driver-related data to generate the driver classifications. Moreover, the storage device 404 may store a database 424 which contains the driver classifications generated by the classification generation program 416.

Further, the storage device 404 may store other databases (not shown) which are utilized in the operation of driver classification computer 106.

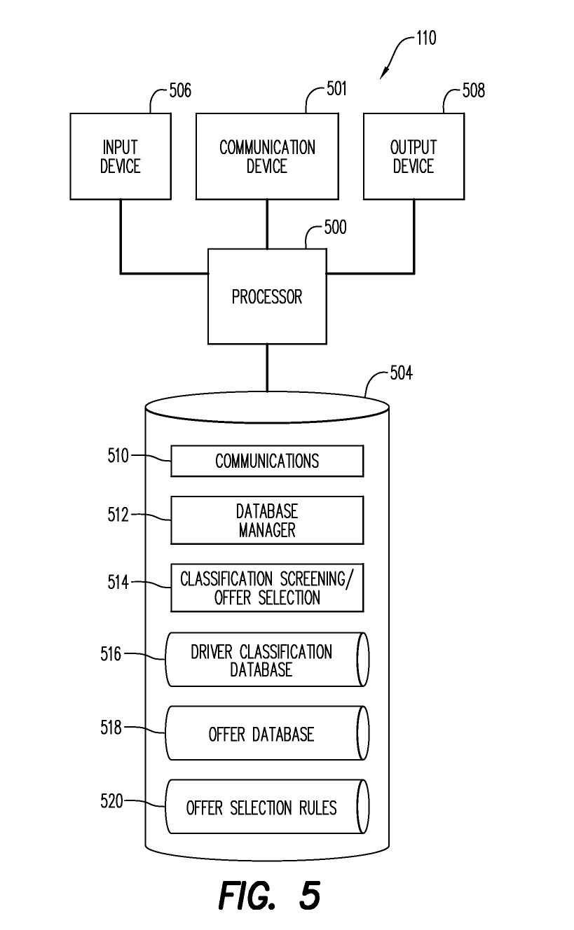

FIG. 5 is a block diagram of the offer selection computer 110 shown in FIG. 1 (which may correspond to the insurance company marketing computer 206 shown in FIG. 2).

The hardware architecture of the offer selection computer 110 may be conventional and may be the same as that of the driver classification computer 106, as depicted in FIG. 4. Thus, the above description of the hardware aspects of the driver classification computer 106 is equally applicable to the hardware aspects of the offer selection computer 110. Nevertheless, the following description is provided to summarize the hardware components of the offer selection computer 110.

The offer selection computer 110 may include a processor 500 that is in communication with a communication device 501, a storage device 504, an input device 506 and an output device 508. The storage device 504 may store an application program 510 that programs the offer selection computer 110 to engage in data communication with other devices. Further, the storage device 504 stores a conventional database management program 512.

In addition, the storage device 504 stores an application program 514 which programs the offer selection computer 110 to screen the driver classifications which it receives and to identify a marketing offer or offers that are suitable for the corresponding driver based on his/her classification. The program 514 may operate in accordance with aspects of the present invention. Details of the operation of the program 514 are described below.

The storage device 504 may further store a database 516 of driver classifications that have been transmitted to the offer selection computer 110. Further, the storage device 504 may store a database 518 of marketing offers to be selectively presented to drivers who correspond to the driver classifications stored in the database 516. Moreover, the storage device 504 may also store a database 520 of rules to be applied by the classification screening program 514 in determining whether to present an offer to a given driver.

The storage device 504 may store other programs, such as one or more operating systems, device drivers, web hosting software, etc. and may also store one or more other databases, such as a database which indicates what offers have been presented to drivers by the offer selection computer 110.

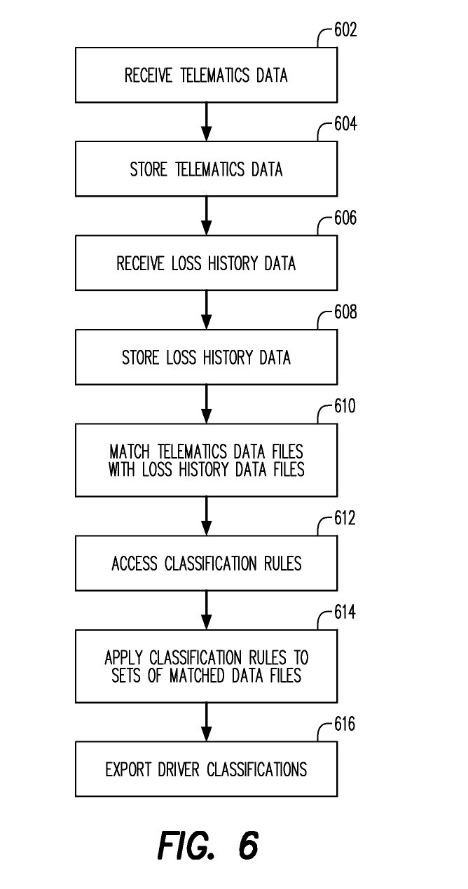

FIG. 6 is a flow chart that illustrates a process that may be performed in accordance with aspects of the present invention by the driver classification computer 106.

At 602 in FIG. 6, the driver classification computer 106 receives telematics data from a data source 102 (FIGS. 1 and 2) such as a computer operated by a telematics vendor. As noted above, the telematics data may be raw data generated by sensors installed in motor vehicles. More preferably, however, the telematics data has been derived by the data source 102 from sensor data to provide a summary of times and places in which vehicles have been operated. For example, for each subject vehicle, the telematics data may contain the following data elements: (a) average time driven per 24 hour period, (b) percentage of time driven during daylight hours, (c) percentage of time driven during night-time hours, (d) percentage of time driven in urban areas, and (e) percentage of time driven in rural areas. In some embodiments, there may be a further breakdown of parameters of operation, such as percentage of time driven at night in urban areas, etc.

Those who are skilled in the art will recognize that the above example of telematics data elements is just one possibility among many, and that there are many other aspects of vehicle operation that may be derived from telematics sensor data and reported as telematics data elements.

In example embodiments described above, the telematics data referred to is generated by sensors installed in motor vehicles and/or is derived from data generated by such sensors. However, in other embodiments, the telematics sensors may be installed in a building for monitoring conditions in the building (such as security of doors and/or windows, or whether water is detected within the building). In other embodiments, telematics sensors may be carried by human beings whose work activities such as lifting items are to be tracked or monitored via the sensors for the purpose of detecting potentially unsafe modes of job performance. In addition, telematics data relating to the location of an individual may be generated using the GPS (Global Positioning System) capabilities of a mobile telephone, a PDA (personal digital assistant) or the like. In some embodiments, the motor vehicles telematically monitored may include watercraft and/or aircraft in addition to or instead of motor vehicles for travel on land.

The telematics data as received by the driver classification computer 106 may be tagged or indexed by a vehicle identification number (VIN) which corresponds to the particular vehicle from which the sensor data was collected. It will be appreciated that the VIN itself does not disclose the name or address or other identifying information relative to the driver of the vehicle.

In some embodiments, the telematics data may be tagged with an index other than the VIN. For example, a central clearinghouse may generate an identifier for each driver that may be used for driver-related data without disclosing the driver's identity. This special identifier may be used in some embodiments instead of the VIN. It should be understood that such a special identifier may be a code that conceals the actual identity of the driver.

Referring again to FIG. 6, at 604 the driver classification computer 106 stores the telematics data in the telematics database 418 (FIG. 4).

At 606, the driver classification computer 106 receives loss history data from a data source 102 other than the above-mentioned telematics vendor. The loss history data may be tagged/indexed with the same indexes (e.g., VINs) as the telematics data.

By using indexes that do not identify the drivers, it may be permissible to disseminate information for marketing applications that regulations and/or policies would not allow to be distributed if accompanied by the drivers' names and addresses.

At 608, the driver classification computer 106 stores the loss history data in the loss history database 420 (FIG. 4).

At 610, the driver classification computer 106, under control of the file matching program 414 (FIG. 4) matches telematics data files with loss history data files. For example, for a given telematics data file pertaining to (but not identifying) a particular driver, the driver classification computer 106 may search the loss history database 420 for a loss history data file indexed by the same VIN as the telematics data file in question. If the driver classification computer 106 finds a matching loss history data file, then the driver classification computer 106 associates the current telematics data file with the matching loss history data file to form a combined data file for the driver. The driver classification computer 106 may perform this function with respect to each telematics data file in the telematics database 418.

At 612, the driver classification computer 106, under control of the classification generation program 416 (FIG. 4), accesses the classification rules database for one or more classification rules that are relevant to the current classification generation job. For example, the classification rules may direct the driver classification computer 106 to characterize the combined data files according to two factors—average number of hours driven per day, and number of accidents during the past three years. The classification rule or rules may prescribe that for the first factor each combined data file is to be categorized as (A) less than one hour per day, (B) one to three hours per day, or (C) more than three hours per day. The classification rule or rules may prescribe that for the second factor each combined file is to be categorized as (A) no accidents, (B) exactly one accident or (C) two or more accidents.

It should be understood that the above is just one example of many possible sets of classification rules that may be applied by the driver classification computer 106 in a particular case.

In another example embodiment, an individual may be telematically monitored by one or more sensors worn on his/her body. An example classification rule may be based on two factors—how frequently, on average, during the working day the individual gets up and moves away from his/her desk, and how many work related injuries the individual has experienced in the past three years. Prospects who receive a favorable classification based on these two factors may be offered attractive rates on individual liability insurance.

In still another example embodiment, an individual's location may be telematically monitored via his/her mobile telephone/PDA. An example classification rule in this case may be based on the following factors: (a) what percentage of the time the individual is present in geographical areas that are correlated with a low risk of death or injury, and (b) one or more demographic factors (e.g., age and/or marital status). Prospects who receive a favorable classification based on these factors may be offered attractive rates on life insurance.

At 614, the driver classification computer 106 applies the classification rule(s) accessed at 612 to all of the combined data files formed at 610. Continuing with the previous example, this may result in a classification for each combined data file (and for the corresponding driver) that includes how the combined data file is categorized for each of the two factors set forth in the example. At 616, the resulting driver classifications may be stored in the driver classification database 424 and exported from the driver classification computer 106 to another device such as the insurance company computer 108 and/or the offer selection computer 110.

In some embodiments, the telematics data file or the loss history data file as received by the driver classification computer 106 may include an address such as an electronic mail address or a mobile telephone number by which a message may be sent to the driver in question. In some embodiments, the address may be included in the driver classification as exported from the driver classification computer 106.

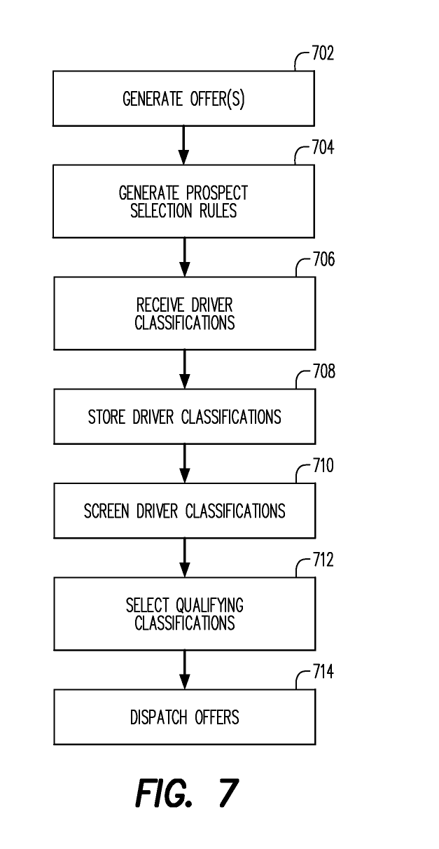

FIG. 7 is a flow chart that illustrates a process that may be performed in accordance with aspects of the present invention by the offer selection computer 110.

At 702, the offer selection computer 110, possibly in response to user input, may generate one or more marketing offers for promoting automobile liability insurance coverage to be provided by the insurance company which operates the offer selection computer 110. For example, the offer selection computer 110 may define two offers, including a first offer which is aimed at very low-risk prospects and which includes certain defined coverage parameters and a very attractive premium rate, and a second offer for somewhat less desirable prospects with the same coverage parameters and a higher but still attractive premium rate.

Then, at 704 the offer selection computer 110 may generate one or more rules which prescribe what driver classification characteristics would be required to trigger submission of each offer to a driver who corresponds to a given driver classification. This too may be done in response to user input.

For example, the prospect selection rules generated at 704 may call for the following: (1) The first offer is to be submitted to drivers whose classifications are in the category of {less than one hour of driving per day and no accidents in the last three years}; and (2) the second offer is to be submitted to drivers whose classifications are in the category of {less than one hour of driving per day and exactly one accident in the last three years}.

According to a prospect selection rule in another embodiment, an offer for individual disability insurance may be made to individuals who on average get up from their desks at least 8 times per working day, and who have not suffered any work related injuries during the past three years.

According to a prospect selection rule in still another embodiment, an offer for life insurance may be made to individuals who on average remain in low risk geographical areas at least 95% of the time and who are less than 50 years old.

Continuing to refer to FIG. 7, at 706 the offer selection computer 110 may receive a download of driver classifications that were generated by the driver classification computer 106 in accordance with the procedure illustrated in FIG. 6. The offer selection computer 110 may receive the driver classifications via the insurance company computer 108 (FIG. 10); alternatively, the offer selection computer 110 may receive the driver classifications directly from the driver classification computer 106.

At 708, the offer selection computer 110 stores the driver classifications received at 706 in the driver classification database 516 (FIG. 5). At 710, the offer selection computer 110 screens the driver classifications in accordance with the offer selection rules generated at 704. That is, the offer selection computer 110 examines each driver classification, and if the driver classification qualifies under the offer selection rules, the offer selection computer 110 selects for the driver in question the marketing offer indicated by the offer selection rules. Accordingly, and continuing the current example, if the current driver classification is in the category {less than one hour of driving per day and no accidents in the last three years}, then the offer selection computer 110 selects the first marketing offer for presentation to the driver in question; if the current driver classification is in the category {less than one hour of driving per day and exactly one accident in the last three years}, then the offer selection computer 110 selects the second marketing offer for presentation to the driver in question; and if the current driver classification is in neither of the two categories, then no marketing offer is selected for presentation to the driver in question. It will be appreciated that selection of a marketing offer for a given driver classification implies that the driver classification is selected to receive a marketing offer, as indicated at 712 in FIG. 7.

At 714, the offer selection computer 110 dispatches the selected offers to the drivers who correspond to the driver classifications selected at 712. For example, the marketing offers may be dispatched by electronic mail or as pop-up displays to be shown on the driver's web-enabled mobile phone. In some embodiments the offer selection computer 110 may dispatch the marketing offers using address information (electronic mail address or mobile phone number) included in the driver classifications. In other embodiments, the driver classifications may include the above mentioned indexes (VIN or special driver identifier) and the offer selection computer 110 may obtain the necessary address information from a third party clearinghouse or the like using the VIN or special driver identifier.

In still other embodiments, the offer selection computer 110 may effect the dispatching of the selected offers indirectly, e.g., by instructing another computer to send out the offers. The other computer may, for example, be operated by a third party, such as the above-mentioned clearinghouse. The instructions to the other computer may, for example, include the text/graphics that make up the offers, and may identify the drivers by the above-mentioned special driver identifier. In some embodiments, the other computer may maintain a database of drivers for direct marketing purposes, including for example the drivers' names and mailing addresses. Thus the other computer may manage a direct mail generation process and may submit the resulting mailings to a postal carrier for mailing to the drivers.

In some embodiments, communications from the offer selection computer 110 to the other computer are encrypted, and the offers selected for the drivers/prospects are decrypted by the other computer when the other computer sends the offers to the drivers/prospects.

In example embodiments described above, the match index for a particular driver was a VIN or a special identifier created and managed by a third party clearinghouse. In another possible embodiment, the match index may be an avatar name that the driver has selected for himself/herself. The avatar name may be associated with an avatar created by the driver in connection with a virtual online environment and may be used by the driver to access his/her participation in the virtual online environment. The driver may have granted permission for his/her avatar name to be used for marketing purposes and to be associated with telematics data and other data pertaining to the driver. Address information for sending messages to the driver may also be associated with his/her avatar name. In some embodiments, the entity which operates the virtual online environment may also function as a third party clearinghouse for marketing support applications.

In a specific example described above, the driver classification computer 106 matches telematics data files with loss history data files to form combined data files that the driver classification computer 106 analyzes to generate driver classifications. Alternatively, however, the driver classification computer 106 may receive one or more types of non-telematics data other than loss history data in addition to or instead of the loss history data. In these cases, the driver classification computer 106 may match the non-telematics data with the telematics data and generate driver classifications from the resulting combined data files in a similar manner to the procedure described above with reference to FIG. 6. Examples of other types of non-telematics data have been listed above, and may include DMV information, demographic information and/or credit scores.

The driver classification computer 106 referred to above may, in some embodiments, be operated by an entity that is independent of the insurance company, and that provides marketing-related services to one or more insurance companies. Alternatively, however, the driver classification computer may be operated by the insurance company itself or by an affiliate of the insurance company. The driver classification computer 106 may in some embodiments be integrated with the offer selection computer 110.

In some embodiments, the telematics data may take the form of, or may include, a driver score that reflects driving behaviors detected by telematics sensors installed in a motor vehicle. The driver score may be generated and maintained by a particular telematics vendor, or may be generated and maintained by a central driver rating agency, in a manner described in U.S. patent application Ser. No. 12/181,463, filed Jul. 29, 2008 (which is commonly assigned herewith and which is incorporated herein by reference). Such a driver score may be tagged with a blind match index, as referred to above, and may be used for marketing activities in which the entity which performs the marketing does not have personally identifying information for the prospects.

The principles of the present invention may be applied in connection with marketing of any and all types of insurance, including but not limited to motor vehicle insurance, disability insurance, life insurance and health insurance. The principles of the present invention may further be applied to financial products other than insurance.

The term “prospects” as used herein and in the appended claims includes drivers of telematically-monitored motor vehicles, individuals who are telematically monitored via GPS capabilities of personal electronics devices and/or via sensors, and owners or renters of premises that are telematically monitored.

The process descriptions and flow charts contained herein should not be considered to imply a fixed order for performing process steps. Rather, process steps may be performed in any order that is practicable.

As used herein and in the appended claims, the term “computer” refers to a single computer or to two or more computers in communication with each other and/or operated by a single entity or by two or more entities that are partly or entirely under common ownership and/or control.

As used herein and in the appended claims, the term “processor” refers to one processor or two or more processors that are in communication with each other.

As used herein and in the appended claims, the term “memory” refers to one, two or more memory and/or data storage devices.

As used herein and in the appended claims, an “entity” refers to a single company or two or more companies that are partly or entirely under common ownership and/or control.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer system comprising:
a communication module for receiving data files;
a data storage module in communication with the data communication module, the data storage module for storing and providing access to the data files received by the communication module, the data files stored in the data storage module including telematics data files and loss history data files, each of said data files including a match index, each match index indicating that a respective one of the data files pertains to a respective driver without indicating the respective driver's identity;
a computer processor for executing programmed instructions and for analyzing the data files;
program memory, coupled to the computer processor, for storing program instruction steps for execution by the computer processor;
a data file matching component, coupled to the computer processor, for using the match indexes to match ones of the telematics data files each with a respective one of the loss history files;
a driver classification component, coupled to the computer processor, for generating driver classifications, each based on a respective pair of data files, the respective pair of data files including one of the telematics data files and a one of the loss history data files that has been matched to said one of the telematics data files by the data file matching component; and
an output device, coupled to the computer processor, for outputting the driver classifications generated by the driver classification component.

2. The computer system of claim 1, wherein each of the driver classifications output from the output device includes address data for transmitting information to a corresponding driver.

3. The computer system of claim 1, wherein the address data is an electronic mail address for the corresponding driver.

4. The computer system of claim 1, wherein the match indexes are vehicle identification numbers.

5. The computer system of claim 1, wherein the telematics data files do not contain information that identifies drivers.

6. The computer system of claim 1, wherein the telematics data files reflect motor vehicle usage by drivers who correspond to the driver classifications.

7. A computerized method for generating a driver classification, the method comprising:
receiving, by a computer, telematics data relating to a vehicle operated by a driver, the telematics data associated with a match index, the match index indicative that the telematics data is pertinent to the driver without indicating the driver's identity;
receiving, by the computer, second data relating to the driver, the second data associated with the match index;
using the match index by the computer to associate the telematics data with the second data; and
using the associated telematics data and second data by the computer to generate the driver classification for the driver.

8. The method of claim 7, wherein the match index is a vehicle identification number.

9. The method of claim 7, wherein the second data includes demographic data.

10. The method of claim 7, wherein the second data includes insurance loss history data.

11. The method of claim 7, wherein the second data includes data obtained from a state department of motor vehicles.

12. The method of claim 7, wherein the second data includes a credit score for the driver.

13. The method of claim 7, wherein the telematics data is indicative of a time, place and/or manner in which the driver has operated a motor vehicle.

14. The method of claim 7, further comprising:
using the driver classification to identify an insurance marketing proposal that is suitable to the driver.

15. The method of claim 14, further comprising:
dispatching the identified insurance marketing proposal to the driver.

16. The method of claim 7, wherein the telematics data is received from a first data source computer, and the second data is received from a second data source computer that is different from the first data source computer.

17. A computer system for generating a driver classification, the computer system comprising:
a processor; and
a memory in communication with the processor and storing program instructions, the processor operative with the program instructions to:
receive telematics data relating to a vehicle operated by a driver, the telematics data associated with a match index, the match index indicative that the telematics data is pertinent to the driver without indicating the driver's identity;
receive second data relating to the driver, the second data associated with the match index;
use the match index to associate the telematics data with the second data; and
use the associated telematics data and second data to generate the driver classification for the driver.

18. The computer system of claim 17, wherein the match index is a vehicle identification number.

19. The computer system of claim 17, wherein the second data includes demographic data.

20. The computer system of claim 17, wherein the second data includes insurance loss history data.

21. The computer system of claim 17, wherein the second data includes data obtained from a state department of motor vehicles.

22. The computer system of claim 17, wherein the second data includes a credit score for the driver.

23. The computer system of claim 17, wherein the telematics data is indicative of a time, place and/or manner in which the driver has operated a motor vehicle.

24. The computer system of claim 17, wherein the processor is further operative with the program instructions to:
use the driver classification to identify an insurance marketing proposal that is suitable to the driver.

25. A computerized method of matching prospects with offers, the method comprising:
receiving, by a computer, a prospect classification that was generated based on a data set, the data set formed by associating telematics data for the prospect with second data for the prospect, the associating having been performed using a match index which indicates that the telematics data and the second data are pertinent to the prospect without indicating the prospect's identity;
selecting, by the computer, an offer for the prospect, without the prospect being identified by the prospect's name;
dispatching the selected offer to the prospect by the computer, the dispatching including one of: (a) sending the offer to the prospect, and (b) instructing another computer to send the offer to the prospect.

26. The method of claim 25, wherein the offer relates to automobile insurance.

27. The method of claim 26, wherein the telematics data relate to a motor vehicle driven by the prospect.
